(19) United States
(12) Patent Application Publication
(10) Pub. No.: US 2014/0217300 A1
(43) Pub. Date: Aug. 7, 2014

(54) DYNAMIC HIGH VOLTAGE BIAS FOR HIGH PRESSURE ION CHAMBERS

(71) Applicant: GENERAL ELECTRIC COMPANY, (US)

(72) Inventor: Dan Jay McCormick, Hudson, OH (US)

(73) Assignee: GENERAL ELECTRIC COMPANY, Schenectady, NY (US)

(21) Appl. No.: 13/717,809

(22) Filed: Dec. 18, 2012

(51) Int. Cl. G01T 1/185

(52) U.S. Cl. CPC G01T 1/185
USPC 250/389

(57) ABSTRACT

An environmental radiation monitor including a high pressure ionization chamber (HPIC) configured to produce a current signal responsive to gamma impingement. The monitor includes an electrometer electrically connected with the HPIC. The electrometer includes an electrical amplifier receiving the current signal. The electrical amplifier is configured to convert the current signal to a voltage signal indicative of gamma impingement. The monitor includes a voltage supply electrically connected to the HPIC to provide a bias voltage amount to the high pressure ionization chamber. The voltage supply is controllable to vary the bias voltage amount provided to the HPIC. The monitor includes a processor operatively connected to the electrometer to receive information indicative of gamma impingement and operatively connected to the voltage supply to control the voltage supply to vary the bias voltage amount in response to received information indicative of gamma impingement. An associated method is also provided.

### BACKGROUND OF THE INVENTION

1. Field of the Invention

The present invention relates to environmental radiation monitoring using a high pressure ion chamber, and specifically relates to voltage bias for the high pressure ion chamber to provide for gamma photon collection/detection.

2. Discussion of Prior Art

Environmental radiation monitors are known and used to detect an amount of radiation at a locality. Radiation monitors can be deployed in the field proximate to known radiation sources such as nuclear power generation stations to monitor radiation levels. Of course, environmental radiation monitors can be deployed anywhere that it is desirable to monitor radiation levels.

In one type of radiation monitor, a high pressure gamma ionization chamber (HPIC) is utilized. In operation, a bias voltage is applied to the HPIC for the purpose of collecting/detecting gamma impingement into the HPIC. The HPIC outputs a current that is indicative of gamma impingement. Generally, there is a desire to have output current be linearly related to the amount of gamma impingement so that an accurate and easily processed output current is provided. However, as the gamma field increases (i.e., increased gamma impingement) so also increases an ionization current within the HPIC, which develops a space charge that alters the electric field in the HPIC. This altered field affects the current output such that it is no longer linear with respect to the gamma impingement.

As mentioned, a bias voltage is applied to the HPIC. The purpose of the bias voltage is to establish a saturation voltage, such that the output current to gamma impingement relationship is linear. Specifically, when the bias voltage is above the saturation voltage amount, the output current to gamma impingement relationship is linear. The actual value of the saturation voltage can vary dependent upon gamma intensity. It is known, to apply a fixed bias voltage that is sufficiently large so that the applied bias voltage is always above the saturation voltage amount regardless of gamma intensity. As can be appreciated, such a large voltage may not be needed. Thus, there is a need for improvements to the technology of bias voltage application to an HPIC.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

In accordance with one aspect, the present invention provides an environmental radiation monitor including a high pressure ionization chamber configured to produce a current signal responsive to gamma impingement. The monitor includes an electrometer electrically connected with the high pressure ionization chamber. The electrometer includes an electrical amplifier receiving the current signal. The electrical amplifier is configured to convert the current signal to a voltage signal indicative of gamma impingement. The monitor includes a voltage supply electrically connected to the high pressure ionization chamber to provide a bias voltage amount to the high pressure ionization chamber. The voltage supply is controllable to vary the bias voltage amount provided to the high pressure ionization chamber. The monitor includes a processor operatively connected to the electrometer to receive information indicative of gamma impingement and operatively connected to the voltage supply to control the voltage supply to vary the bias voltage amount in response to received information indicative of gamma impingement.

In accordance with another aspect, the present invention provides a method of operating an environmental radiation monitor that includes a high pressure ionization chamber configured to produce a current signal responsive to gamma impingement. The monitor includes an electrometer electrically connected with the high pressure ionization chamber. The electrometer includes an electrical amplifier receiving the current signal. The electrical amplifier is configured to convert the current signal to a voltage signal indicative of gamma impingement. The monitor includes a voltage supply electrically connected to the high pressure ionization chamber to provide a bias voltage amount to the high pressure ionization chamber. The voltage supply is controllable to vary the bias voltage amount provided to the high pressure ionization chamber. The method includes receiving information indicative of gamma impingement at the processor. The method includes controlling the voltage supply via the processor to vary the bias voltage amount in response to the received information indicative of gamma impingement.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematic isometric view of an example environmental radiation monitor in an example arrangement with associated example equipment to be used in a field application;

FIG. 2 is a schematic isometric view of example components of the environmental radiation monitor of FIG. 1;

FIG. 3 is a schematic electrical diagram of an example of the environmental radiation monitor of FIG. 1 and in accordance with an aspect of the present invention; and

FIG. 4 is a top level flow diagram of an example method of dynamically varying a bias voltage amount within environmental radiation monitor of FIG. 3.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

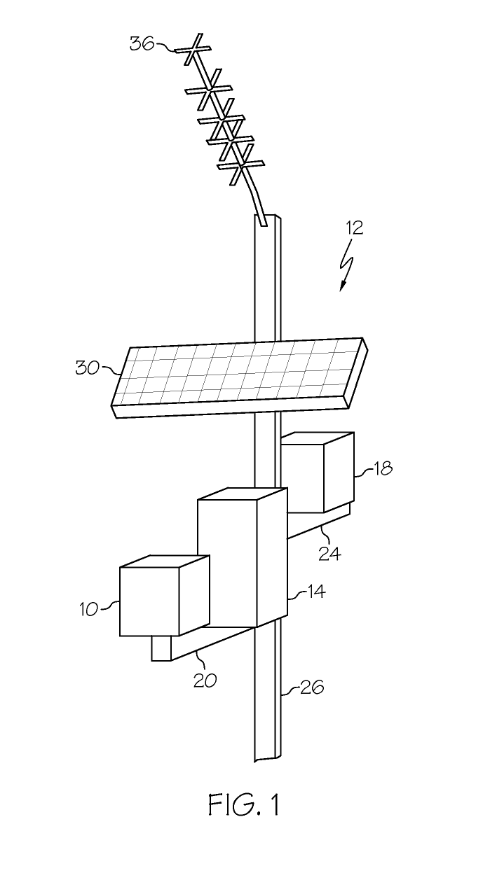

An example embodiment of an environmental radiation monitor 10 is schematically shown within FIG. 1. The environmental radiation monitor 10 is shown in one example arrangement 12 with associated equipment in a field application. It is to be appreciated that FIG. 1 merely shows one example of possible structures/configurations/etc. and that other examples are contemplated within the scope of the present invention. Generally, such an arrangement 12 is placed at an exterior location so that the environmental radiation monitor 10 can perform the function of monitoring low-level gamma radiation in the local area atmosphere. It is to be appreciated that the gamma radiation may be from known or, at times, unknown sources.

The arrangement 12 can include associated equipment, such as a controls package located within a protective enclosure 14. Such other, associated equipment operates in conjunction with the environmental radiation monitor 10. An external power supply, such as a battery located within a protective enclosure 18, can also be provided within the arrangement 12. The power supply can be used to provide power within the arrangement 12, including possible use by the environmental radiation monitor 10. The environmental radiation monitor 10, the controls package located within a protective enclosure 14, and the external power supply located within a protective enclosure 18 can be located upon any structural configuration. Within the shown example, these portions of the arrangement 12 are located on first and second arms 20 and 24 extending from a central post 26. The central post 26 serves as a firm support for the operating equipment while anchoring the arrangement 12 at a desired location.

Additional associated equipment of the arrangement 12 may include a solar panel array 30. The solar panel array 30 can be configured to supply an electrical charge to the external power supply (e.g., battery). Communication equipment, including an antenna 36 or similar such as a satellite dish, etc., can also be provided within arrangement 12 to permit communication between the controls package and a remotely located device/network/etc. (not shown). For example, the antenna 36, or similar such as a satellite dish, etc., can transmit a signal conveying acquired data from the environmental radiation monitor 10 and receive software updates from the remotely located device/network/etc. As another example, the antenna 36 can be used to connect/communicate with a cellular telephone network. Such, connection/communication can provide/include an internet connection.

It is to be appreciated that the arrangement 12 shown in FIG. 1 is not limiting and other arrangements are also contemplated. For example, the environmental radiation monitor 10 and associated equipment can be housed within an enclosed structure that is typical of structures housing meteorological measuring equipment. At least one wall or door of the enclosed structure can include louvers to permit a free exchange of air between the interior and the exterior of the enclosed structure. In another example, the environmental radiation monitor 10 and associated equipment can be located on a mobile device. The environmental radiation monitor 10 can be used in a number of different arrangements (e.g., different from arrangement 12) and the environmental radiation monitor 10 can be used individually or in plurality to measure various aspects of environmental radiation levels such as flow path, concentration, etc.

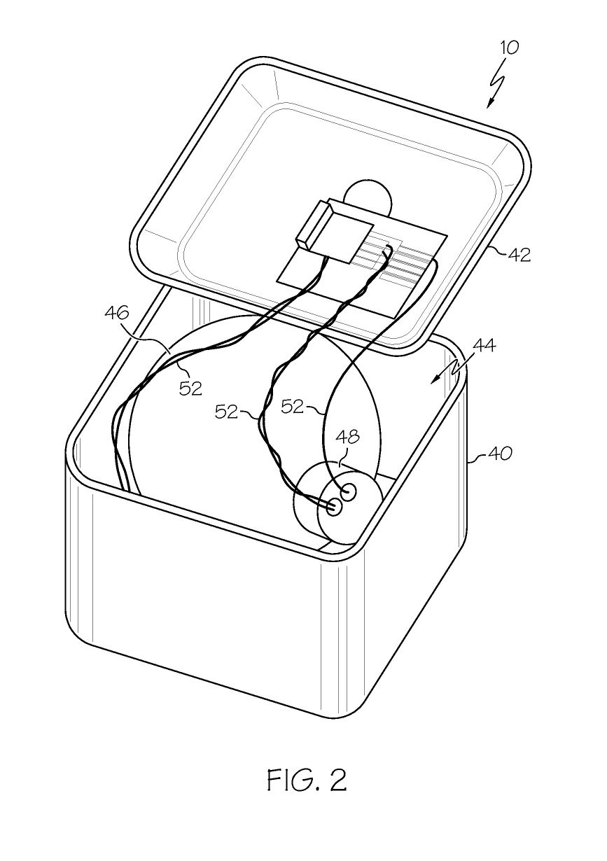

Turning to FIG. 2, an example schematic representation of the environmental radiation monitor 10 is shown. The environmental radiation monitor 10 can include a protective enclosure 40. The shown example enclosure 40 includes a lid 42 and the enclosure bounds an interior volume 44 that provides space for individual components of the environmental radiation monitor 10. The shown enclosure 40, lid 42 and interior volume 44 are only generic representations and can be varied. As such, the enclosure 40, lid 42 and interior volume 44 need not be limitations upon the present invention.

One or more of the mating surfaces of the enclosure 40 and the lid 42 can be provided with seals. It is to be appreciated that the interior volume 44 of the enclosure 40 can be sealed so that little or no ambient atmosphere can enter the protective enclosure 40 during field deployment of the environmental radiation monitor 10. In addition to protection from atmospheric conditions such as humidity, the enclosure 40 and the lid 42 can also help protect the environmental radiation monitor 10 from physical damage. Protection from physical damage during handling or deployment can be provided by an amount of cushion material and or seating surfaces (not shown for clarity purposes) within the interior volume 44. Again, the details concerning the enclosure, etc. need not be limitations upon the present invention.

The schematic representation of the environmental radiation monitor 10 shown in FIG. 2 includes one possible arrangement of some individual components of the environmental radiation monitor. A high pressure ionization chamber (HPIC) 46 of the environmental radiation monitor 10 is located within the interior volume 44 of the enclosure 40. The HPIC 46 is configured to create an output of a current signal that is proportional to the amount of gamma radiation passing into the HPIC. This gamma radiation that passes into the HPIC 46 can be referred to simply as gamma impingement. An electrometer enclosure 48 mounted to an exterior wall of the HPIC 46 can include an electrometer of the environmental radiation monitor 10 that will be described below. The electrometer enclosure 48 can be constructed of metal or other materials. The electrometer enclosure 48 can also be sealed so that little or no ambient atmosphere can enter the electrometer enclosure 48 during field deployment of the environmental radiation monitor 10. The HPIC 46 and the electrometer within the electrometer enclosure 48 are electrically connected to one or more components 50 of the environmental radiation monitor 10 through lines 52. The components 50 connected to the HPIC 46 and the electrometer within the electrometer enclosure 48 are only generically shown within FIG. 2. The components 50 are further connected (not shown) to the controls package located within a protective enclosure 14 (FIG. 1), the external power supply located within the protective enclosure 18 and/or the communication equipment (e.g., the antenna 36 or similar) within arrangement 12. Discussion of some of such components is provided below.

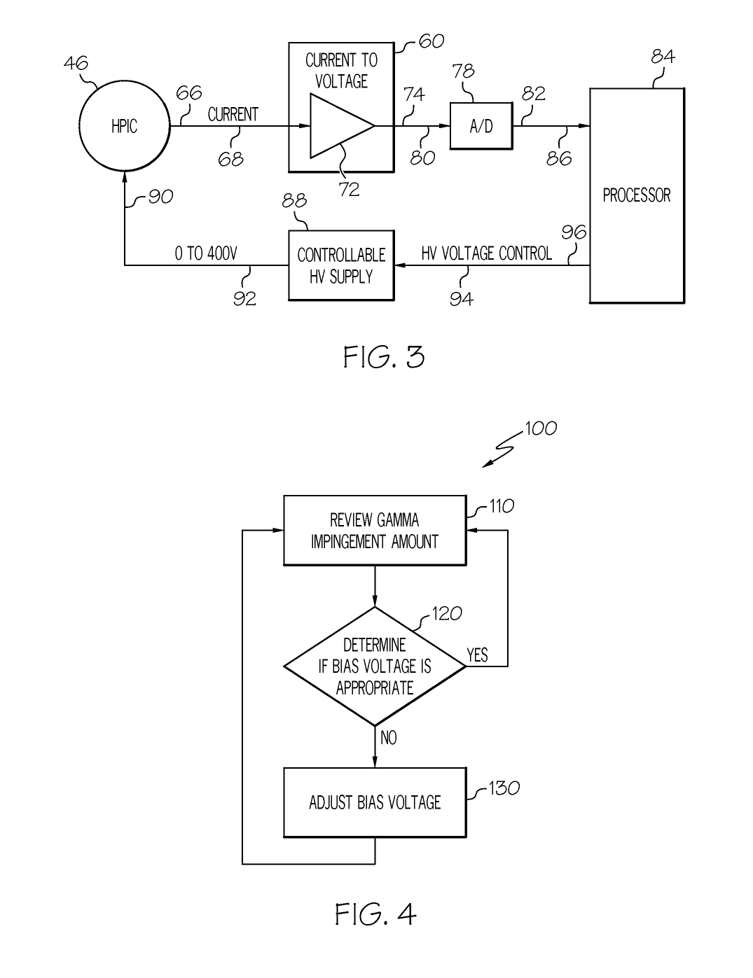

Turning to FIG. 3, an electrical schematic of an example of the environmental radiation monitor 10 in accordance with an aspect of the present invention is shown. Specifically, the HPIC 46 and an example electrometer 60 are schematically shown along with additional components of the environmental radiation monitor 10 operatively connected to the HPIC 46 and the electrometer 60.

It will be recalled that the HPIC 46 is configured to produce a current signal responsive to gamma impingement. During desired operation, the HPIC 46 creates a current signal 66 in proportional to the amount of gamma radiation passing into the HPIC. The current signal 66 can be of relatively small magnitude. In one example, the current signal 66 is about 1×10⁻¹¹ amperes (amps). In another example, the current signal 66 is about 1×10⁻¹³ amps.

The electrometer 60 is electrically connected 68 with the HPIC 46 to receive the current signal 66 from the HPIC. The electrometer 60 includes an electrical amplifier 72 that receives the current signal 66. The electrical amplifier 72 is configured to convert the current signal to a voltage signal 74 indicative of gamma impingement. It is to be appreciated that the electrometer 60 may include various sub-circuits/other components. For example, the electrometer may include one or more resistors, capacitors, and switches connected (e.g., in parallel) to the amplifier. The specifics of such sub-circuits/other components need not be specific limitations upon the present invention.

An analog to digital (A/D) converter 78 is operatively connected 80 to the output of the amplifier 72 of the electrometer 60. Output of the A/D converter 78 is a digital signal 82 indicative of the voltage output from the amplifier 72. As such, the digital signal 82 from the A/D converter 78 is thus indicative of the gamma impingement.

A processor 84 is operatively connected 86 to the output of the A/D converter 78 to receive the digital signal 82. Because the A/D converter 78 is in turn operatively connected to the electrometer 60, the processor 84 can be considered to be operatively connected to the electrometer 60 through the A/D converter 78 for receiving information indicative of gamma impingement.

The processor 84 can be of various constructions and configurations and thus need not be a specific limitation upon the present invention. As examples, the processor 84 may include a microprocessor, a microcontroller, a digital signal processor, an application specific integrated circuit, a field-programmable gate array, discrete logic circuitry, or the like. It is to be appreciated that the processor 84 can be provided as circuits and/or portions of circuits, and can be implemented via discrete electrical components, integrated circuits, and/or through the execution of program instructions stored in a memory of the processor. Along these lines the memory may store program instructions. The memory may include one or more volatile, non-volatile, magnetic, optical, or electrical media, such as read-only memory (ROM), random access memory (RAM), electrically-erasable programmable ROM (EEPROM), flash memory, or the like.

The processor 84 can carry-out any desired process with/upon the digital, gamma-impingement indicative signal. For example, gamma impingement indicative information conveyed by the digital voltage signal 82 can be saved in memory for retrieval at a later time through a suitable output. As previously mentioned, the components, such as the processor 84 may be connected (not shown) to other portions of the arrangement 12. As such another example of a process that can be performed by the processor 84 is the preparation of current or saved gamma impingement indicative information for conveyance/communication to a location remote from the arrangement 12. For example, the antenna 36, or similar such as a satellite dish, etc., can be employed to transmit a signal conveying gamma impingement indicative information from the environmental radiation monitor 10 to the remotely located device/network/etc. As another example of a process that can be performed by the processor 84, the processor may engage in a two-way communication, again employing the antenna 36, or similar such as a satellite dish, etc., such that information/instructions from the remotely located device/network/etc. can be acted upon by the processor and the overall arrangement 12.

As still another example of a process that can be performed by the processor 84, the processor can perform one or more types of analysis upon the gamma impingement indicative information. Focusing upon one specific type of analysis is to monitor/analyze the amount/rate of gamma impingement (e.g., dose rate). As discussed above, gamma detection occurs within the HPIC 46. In operation, a bias voltage 90 is applied to the HPIC 46 for the purpose of collecting/detecting gamma impingement into the HPIC. A high voltage supply 88 is operatively connected 92 to the HPIC 46 to provide the bias voltage 90 to the HPIC 46. Specifically, the HPIC 46 is electrically connected 92 to the high voltage supply 88 via a conductive line or the like.

As discussed, the HPIC 46 outputs a current 66 that is indicative of gamma impingement. Generally, there is a desire to have output current 66 from the HPIC 46 be linearly related to the amount of gamma impingement so that an accurate and easily processed output current is provided. However, as the gamma field increases (i.e., increased gamma impingement) so also increases an ionization current within the HPIC 46, which develops a space charge that alters the electric field in the HPIC. This altered field can affect the current output 66 such that it may no longer be linear with respect to the gamma impingement.

As mentioned, the bias voltage 90 is applied to the HPIC 46. The purpose of the bias voltage 90 is to establish a saturation voltage, such that the output current 66 to gamma impingement relationship is a linear relationship. Specifically, when an amount of bias voltage 90 is above the saturation voltage amount, the output current 66 to gamma impingement relationship is linear. The actual value of the saturation voltage can vary dependent upon gamma intensity. In general, a higher gamma intensity impingement, also known as a dose rate, requires a higher amount of bias voltage 90 for saturation voltage. It is possible to simply apply a fixed bias voltage amount that is sufficiently large so that the applied bias voltage amount is always above the saturation voltage amount regardless of gamma intensity. However, such as excessive bias voltage is often not needed and can be considered to be unnecessary power consumption.

In accordance with an aspect of the present invention, the high voltage supply 88 is controllable to vary the bias voltage 90 amount provided to the HPIC 46. In other words, the bias voltage amount is dynamically changed over time.

The processor 84 is operatively connected 94 to the high voltage supply 88. The processor 84 provides a control signal 96 to the high voltage supply 88 so as to control (e.g., vary) the amount of bias voltage 90 in response to received information indicative of gamma impingement and/or analysis of the gamma impingement information by the processor 84. In one example, the processor 84 provides control so that the amount of bias voltage 90 is within a range of 0 to 400 volts. Of course, it is contemplated that other ranges can be used.

The control of the bias voltage amount can take various forms. For example the bias voltage amount control can be performed in real time based upon the received/analyzed information indicative of gamma impingement. The bias voltage amount control can be performed via sampling of the information indicative of gamma impingement amount (e.g., dose rate) at a set interval. Any desired, determined change to the bias voltage amount can also be made at a set interval (e.g., the same interval). In one example, the set interval is one second, approximately one second or at a similar time period. A one second time interval can be an appropriate interval if the high pressure ionization chamber has a time constant on the order of about one second. Thus, the bias voltage amount is dynamically changed to accommodate the current gamma impingement amount (e.g., dose rate) in real time.

It is possible that a nominal gamma field and thus gamma impingement amount (e.g., dose rate) is very low for all but a small period of time. It is also possible that gamma impingement amount (e.g., dose rate) as measured by the chamber never exceeds normal background levels. Thus in accordance with the present invention, the bias voltage amount can be applied at a relatively low level, as compared to a constant, non-dynamic bias voltage amount that is kept relatively high to ensure that saturation voltage would always be present. In one example, for a vast majority of the time the bias voltage amount could be something like 20 volts instead of a nominal 400V. Of course, these values are just examples and need not be specific limitations upon the present invention.

An example method 100 of operating the environmental radiation monitor 10 is generally described in FIG. 4. Specifically, the method 100 is focused upon the control the voltage supply to vary the bias voltage amount in response to received information indicative of gamma impingement. The method 100 can be performed by the example environmental radiation monitor 10 shown in FIG. 3. The method 100 includes the step 110 of reviewing the gamma impingement amount (e.g., dose rate) to determine amount or value. The review can be of the received and or analyzed information indicative of gamma impingement.

The method includes the step 120 of determining if the bias voltage amount is currently appropriate. Recall that the purpose of the bias voltage is to establish a saturation voltage, such that the output current to gamma impingement relationship is linear. As such, there is a desire to keep the bias voltage amount above the saturation voltage amount so that the output current to gamma impingement relationship is linear. If a higher gamma intensity impingement is occurring, an increase of the bias voltage amount may be merited. Conversely, if lower gamma intensity impingement is occurring, a decrease of the bias voltage amount may be merited. The determination can be via any suitable analysis such has comparison of impingement amount to various thresholds.

If the determination within Step 120 is affirmative (i.e., yes, the bias voltage amount is appropriate), the method 100 simply loops again to step 110. Upon returning to step 110, the method 100 again reviews the gamma impingement amount (e.g., dose rate) to determine amount or value.

If the determination within Step 120 is negative (i.e., no, the bias voltage amount is not appropriate), the method 100 proceeds to step 130. At step 130, an adjustment of the bias voltage amount is made. The adjustment may be to increase or decrease the bias voltage amount in a desired manner. Upon completion of step 130, the method 100 simply loops again to step 110 to again review the gamma impingement amount (e.g., dose rate) to determine amount or value.

In the described examples, the method and apparatus provide a means of controlling bias voltage amount to the HPIC. The method and apparatus can thus help control and conserve energy.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. An environmental radiation monitor including:
a high pressure ionization chamber configured to produce a current signal responsive to gamma impingement;
an electrometer electrically connected with the high pressure ionization chamber, the electrometer including an electrical amplifier receiving the current signal, the electrical amplifier being configured to convert the current signal to a voltage signal indicative of gamma impingement;
a voltage supply electrically connected to the high pressure ionization chamber to provide a bias voltage amount to the high pressure ionization chamber, the voltage supply is controllable to vary the bias voltage amount provided to the high pressure ionization chamber; and
a processor operatively connected to the electrometer to receive information indicative of gamma impingement and operatively connected to the voltage supply to control the voltage supply to vary the bias voltage amount in response to received information indicative of gamma impingement.

2. The environmental radiation monitor according to claim 1, wherein the processor is configured to control the voltage supply such that the bias voltage amount is dynamic during operation.

3. The environmental radiation monitor according to claim 1, wherein the processor is configured to control the voltage supply such that the bias voltage amount provides a saturation voltage at the high pressure ionization chamber during operation of the environmental radiation monitor.

4. The environmental radiation monitor according to claim 3, wherein the processor is configured to control the voltage supply such that the bias voltage amount provides the saturation voltage at the high pressure ionization chamber during variation of gamma impingement amount.

5. The environmental radiation monitor according to claim 4, wherein the processor is configured to control the voltage supply such that the bias voltage amount is increased in response to increase in gamma impingement amount.

6. The environmental radiation monitor according to claim 4, wherein the processor is configured to control the voltage supply such that the bias voltage amount is decreased in response to decrease in gamma impingement amount.

7. The environmental radiation monitor according to claim 1, wherein the processor is configured to control the voltage supply in real time during operation of the environmental radiation monitor.

8. The environmental radiation monitor according to claim 7, wherein the processor is configured to sample the information indicative of gamma impingement amount at a set interval.

9. The environmental radiation monitor according to claim 8, wherein the processor is configured to determines possible change to the bias voltage amount at the set interval.

10. The environmental radiation monitor according to claim 9, wherein the set interval is approximately one second.

11. A method of operating an environmental radiation monitor that includes a high pressure ionization chamber configured to produce a current signal responsive to gamma impingement, an electrometer electrically connected with the high pressure ionization chamber, the electrometer including an electrical amplifier receiving the current signal, the electrical amplifier being configured to convert the current signal to a voltage signal indicative of gamma impingement, a voltage supply electrically connected to the high pressure ionization chamber to provide a bias voltage amount to the high pressure ionization chamber, the voltage supply is controllable to vary the bias voltage amount provided to the high pressure ionization chamber, and a processor operatively connected to the electrometer and operatively connected to the voltage supply, the method including:
receiving information indicative of gamma impingement at the processor; and
controlling the voltage supply via the processor to vary the bias voltage amount in response to the received information indicative of gamma impingement.

12. The method according to claim 11, wherein the step of controlling the voltage supply via the processor includes controlling the voltage supply such that the bias voltage amount is dynamic during operation.

13. The method according to claim 11, wherein the step of controlling the voltage supply via the processor includes controlling the voltage supply such that the bias voltage amount provides a saturation voltage at the high pressure ionization chamber during operation of the environmental radiation monitor.

14. The method according to claim 13, wherein the step of controlling the voltage supply via the processor includes controlling the voltage supply such that the bias voltage amount provides the saturation voltage at the high pressure ionization chamber during variation of gamma impingement amount.

15. The method according to claim 11, wherein the step of controlling the voltage supply via the processor includes controlling the voltage supply such that the bias voltage amount is increased in response to increase in gamma impingement amount.

16. The method according to claim 11, wherein the step of controlling the voltage supply via the processor includes controlling the voltage supply such that the bias voltage amount is decreased in response to decrease in gamma impingement amount.

17. The method according to claim 11, wherein the step of controlling the voltage supply via the processor includes controlling the voltage supply in real time during operation of the environmental radiation monitor.

18. The method according to claim 11, wherein the step of receiving information indicative of gamma impingement at the processor includes the processor sampling the information indicative of gamma impingement amount at a set interval.

19. The method according to claim 18, wherein the step of controlling the voltage supply via the processor includes determining possible change to the bias voltage amount at the set interval.

20. The method according to claim 19, wherein the set interval is approximately one second.
